(19) United States
(12) Patent Application Publication
(10) Pub. No.: US 2014/0025465 A1
(43) Pub. Date: Jan. 23, 2014

(54) Tracking Pre-Purchase/Post-Purchase Shopping Activity

(71) Applicants: Dean F. Herring, Youngsville, NC (US); Adrian X. Rodriguez, Durham, NC (US); Jeffrey J. Smith, Raleigh, NC (US); Suman S. Palavalli, Bangalore (IN)

(72) Inventors: Dean F. Herring, Youngsville, NC (US); Adrian X. Rodriguez, Durham, NC (US); Jeffrey J. Smith, Raleigh, NC (US); Suman S. Palavalli, Bangalore (IN)

(73) Assignee: International Business Machines Corporation, Armonk, NY (US)

(21) Appl. No.: 13/554,154

(22) Filed: Jul. 20, 2012

(51) Int. Cl. G06Q 30/02

(52) U.S. Cl. 705/14.25

(57) ABSTRACT

A mechanism is provided for tracking and facilitating pre-shopping/post-purchase activity. An indication is received that a user has completed a task in a set of tasks of a quest, where the quest is a pre-purchase/post-purchase shopping activity quest. Verification is made as to whether the task has been completed. Responsive to verifying the task has been completed, a determination is made as to whether all of the set of tasks of the quest have been completed. Responsive to all of the set of tasks being completed, a presentation is initiated of an agreed-upon reward to the user. All information from quest is then submitted to a sponsor of the quest.

### BACKGROUND

The present application relates generally to an improved data processing apparatus and method and more specifically to mechanisms for tracking, facilitating, and encouraging pre-purchase/post-purchase shopping activity.

Predicting consumer behavior before it happens comprises predicting what consumers want, predicting when consumers want it, and how the consumers will react to new product innovations, which is all considered “marketing.” Marketers all want to “build a better mousetrap.” That is, to market a product or service that is perfectly positioned to entice and encourage customers to buy it. Predicting consumer behavior with data-driven marketing and market research is just part of a marketer's job.

Market research is just one way to uncover part of what consumers want, but even people with the best intentions often provide false or inaccurate information during the research process. Thus, businesses need to look at the problems customers are trying to solve, what methods and work-arounds customers are using to solve the problem, and the context in which the problem is being solved. Then, products and services may be designed.

Once the product or service is designed and provided for sale, then marketers strive to improve the customer's “want” for the product by observing and analyzing the customer experience, and then modifying any previous predictions of customer behavior. Customer experience largely includes observable and measurable behaviors in both public (e.g., stores) and private (e.g., online shopping within the customer's home, mobile shopping using the customer's own mobile device) marketing environments. Prediction typically involves costly hours of in-person observation and/or video recording analysis, connection with purchasing behavior, and aggregate analysis. In addition to in-person observation and/or video recording analysis, there is also secret shopper input as well as interactive input from applications that allow shoppers to complete challenges and earn points and/or rewards as the customers shop. That is, many retailers provide loyalty or reward cards that reward different types of shopper behavior based upon the purchasing behavior and the items purchased by the customer.

### SUMMARY

In one illustrative embodiment, a method, in a data processing system, is provided for tracking and facilitating pre-shopping/post-purchase activity. The illustrative embodiment receives an indication that a user has completed a task in a set of tasks of a quest. In the illustrative embodiment, the quest is a pre-purchase/post-purchase shopping activity quest. The illustrative embodiment verifies whether the task has been completed. The illustrative embodiment determines whether all of the set of tasks of the quest have been completed in response to verifying the task has been completed. The illustrative embodiment initiates a presentation of an agreed-upon reward to the user in response to all of the set of tasks being completed. The illustrative embodiment submits all information from quest to a sponsor of the quest.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts an exemplary pre-purchase shopping activity tracking mechanism in accordance with an illustrative embodiment; and

FIGS. 4A and 4B depict a flowchart of the operation performed by a pre-purchase shopping activity tracking mechanism in accordance with an illustrative embodiment.

### DETAILED DESCRIPTION

As stated previously, once a product or service is provided for sale, marketers strive to improve the customer's “want” for the product by observing and analyzing the customer experience, and then the marketers modify any previous predictions of customer behavior. Prediction typically involves costly hours of in-person observation, video recording analysis, secret shopper analysis, attitudinal research such as focus groups, interviews, and surveys, and/or interactive application analysis, connection with purchasing behavior, and aggregate analysis, which is all based upon in-store customer shopping experience. However, with the evolution of the Internet, many customers start their shopping experience hours, days, weeks, etc., before the actual purchase of the product and/or service is ever made. That is, for example, prior to buying an automobile, a potential customer may start by looking for automobiles that hold a number of persons, looking for cars with a certain fuel mileage, looking for who provides the best deals, or the like, all of which may be performed on the Internet. Then, the potential customer may research reliability, speak with owners of similar automobiles, check for financing, or the like. Some pre-purchase activities may be observed and measured easily by marketers (e.g., whether a test drive leads to a sale); others cannot (e.g., talking with a current customer). Only after the potential customer performs all of these “pre-purchase” activities, will the potential customer actually become a purchasing customer by purchasing an automobile that is selected based upon the pre-purchase activities, which would be observed and/or analyzed by current marketing.

Thus, the illustrative embodiments provide mechanisms that track pre-purchase as well as post-purchase shopping activities and reward potential customers based on the customer's pre-purchase/post-purchase shopping activities. That is, utilizing the mechanisms of the illustrative embodiments businesses may propose rewards based upon non-purchase activities conducted via email, the Internet, social media, apps, non-purchase store visits, or the like. Utilizing the mechanisms of the illustrative embodiments, a customer creates and/or completes ‘quests’, which are collections of goals and tasks that the customer completes during their own pre-purchase/post-purchase activities. These quests may then be analyzed by a business in relation to purchasing behavior to determine which quests may be most useful for marketing. These quests could be combined with other data collected by a marketer to unlock additional quests, build towards alternate achievements, optimize rewards for the shopper, etc. While these quests may be business-created quests, the illustrative embodiments recognize that the quest may also include business-created quests modified by the customer, customer generated quests tied to the business, quests generated by another customer related to a previous purchase made from the business, quests suggested by other potential customers, or the like. Additionally, the quest may provide context around the intent of the particular quest by allowing the user to provide comments along with the particular action of the quest being performed, thereby providing guidance to the marketers of the business.

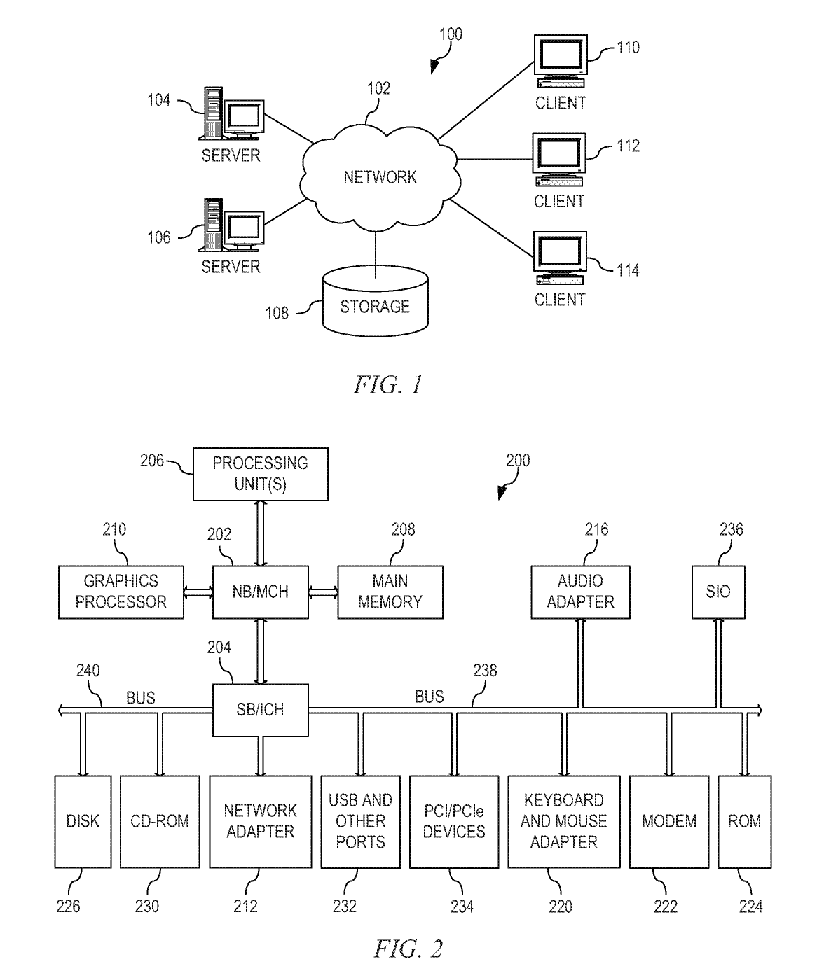

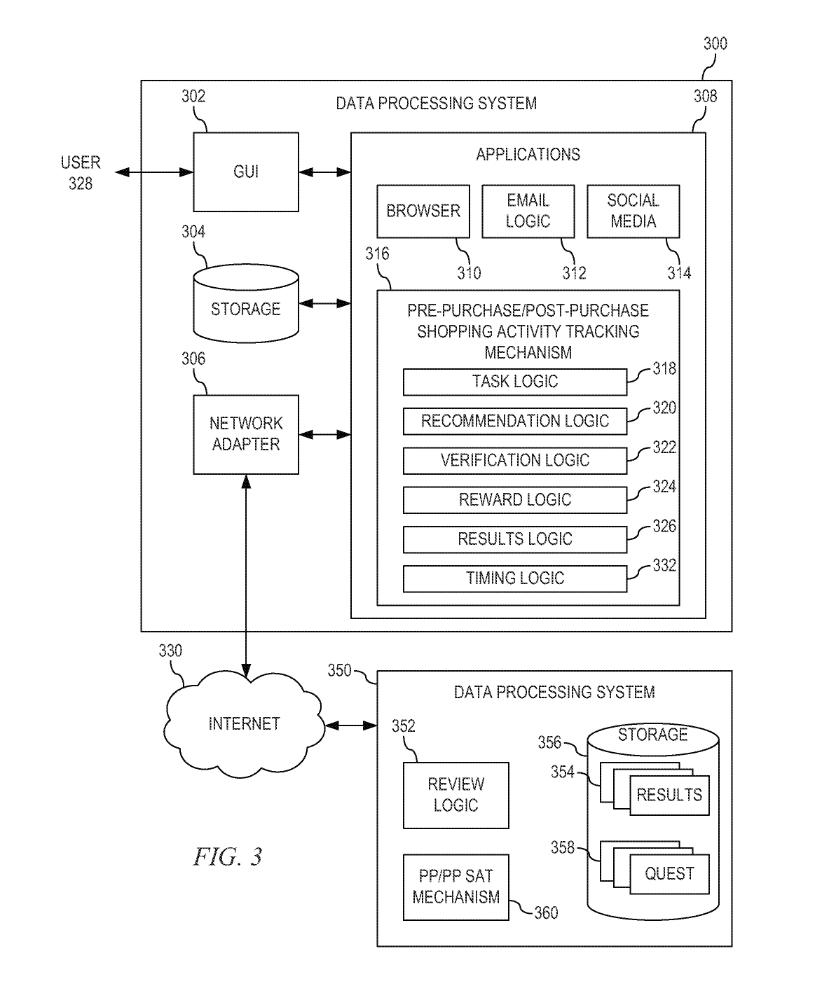

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above. FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft™ Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p®® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

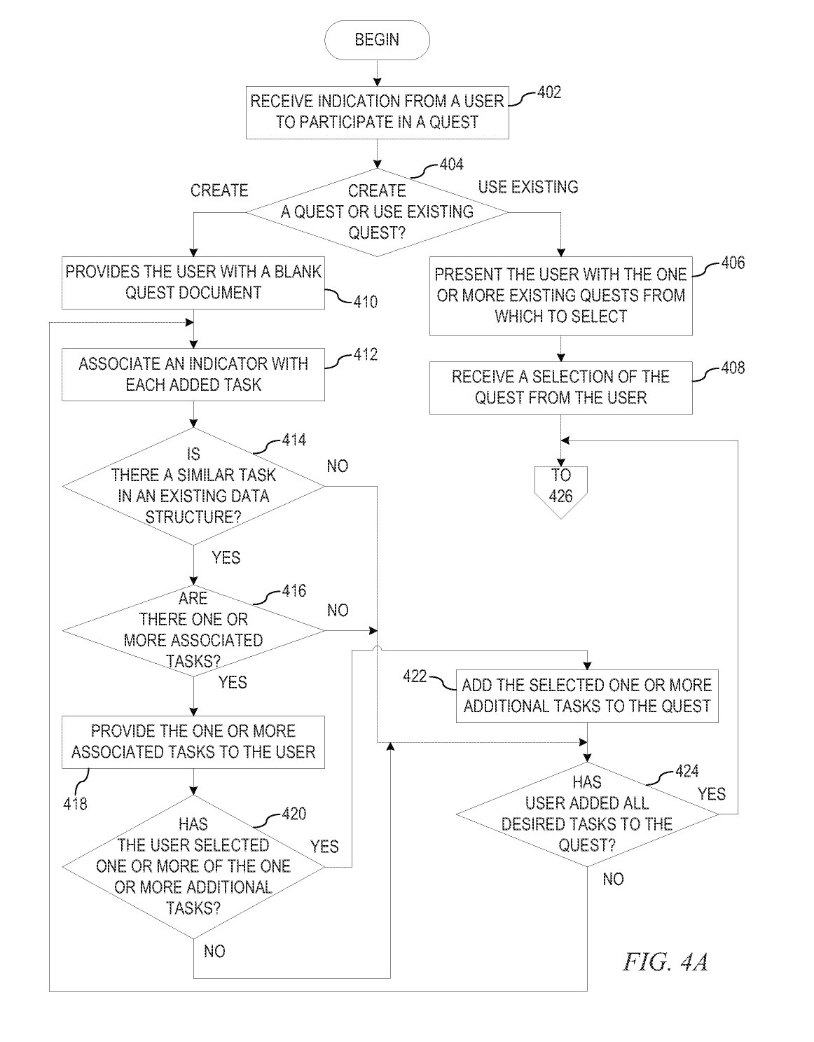

Again, the illustrative embodiments provide mechanisms that track pre-purchase as well as post-purchase shopping activities and reward potential customers based on the customer's pre-purchase/post-purchase shopping activities because completion of the pre-purchase/post-purchase shopping activities positively correlates with increased customer satisfaction, reduced buyer's remorse, or the like, as viewed by the sponsor of the quest. FIG. 3 depicts an exemplary pre-purchase/post-purchase shopping activity tracking mechanism in accordance with an illustrative embodiment. Data processing system 300 comprises graphical user interface (GUI) 302, storage 304, network adapter 306, as well as one or more applications 308, such as browser 310, email logic 312, social media 314, pre-purchase/post-purchase shopping activity tracking mechanism 316, or the like. Pre-purchase/post-purchase shopping activity tracking mechanism 316 comprises task logic 318, recommendation logic 320, verification logic 322, reward logic 324, and results logic 326.

As user 328 interacts with data processing system 300 via GUI 302, user 328 may see an advertisement for a particular product or service while visiting a Website via browser 310, receiving an email via email logic 312, interacting via social media 314, or the like. Upon selection of a link associated with the advertisement, user 328 may be requested to participate in a ‘quest’ or ‘sub-quest’. In the illustrative embodiments, a quest is a collection of tasks that user 328 completes during pre-purchase/post-purchase activities for which user 328 will receive a reward, such as a coupon, a discount, a “master quester” badge, or the like. Similarly, a sub-quest is a portion of the collection of tasks of a quest that user 328 is required to complete during pre-purchase/post-purchase activities for which user 328 will receive a lesser reward. That is, once user 328 completes a certain number of tasks within the ‘quest’, thereby completing a ‘sub-quest’, user 328 will receive a reward, such as a smaller valued coupon, a smaller discount, receiving an “expert quester” badge, or the like. The following description utilizes the term quest to represent both the previously described ‘quest’ and ‘sub-quest’.

If user 328 indicates a desire to participate in the quest, pre-purchase/post-purchase shopping activity tracking mechanism 316 may be loaded onto data processing system 300, as shown in FIG. 3, or an interactive link may be initiated with pre-purchase/post-purchase shopping activity tracking mechanism 360 on another data processing system, such as data processing system 350 which is associated with a sponsor of the quest. Upon indication of the desire to participate in the quest, task logic 318 presents user 328 with an option to select a quest from one or more existing quests or create a new quest. For the one or more existing quests, task logic 318 may access the one or more existing quests at a business Website who is a sponsor, such as a retailer, a department store collaborating with a retailer, or the like, of the advertisement via network adapter 306 and Internet 330, or elsewhere on the Internet. The one or more existing quests may be quests that the sponsor built themselves or a quest performed by another user who eventually purchased the product or service associated with the advertisement. If user 328 chooses to create their own quest, task logic 318 provides user 328 with a blank quest document in which user 328 may list tasks/activities user 328 plans to perform in the pre-purchase/post-purchase of the associated product or service. As user 328 adds tasks to the quest document, task logic 318 associates an indicator with each task so that, upon completion of the task, user 328 may provide a completion indication.

Further, as user 328 adds a task to the quest document, recommendation logic 320 may make one or more additional task recommendations by comparing the current tasks listed in the quest document to a list of tasks or tasks in the one or more existing quests. That is, recommendation logic 320 may identify a similar task in the list of tasks or the tasks in the one or more existing quests and determine whether the identified task has one or more associated tasks. If there are associated task(s), then recommendation logic 320 may provide the associated task(s) to user 328 via GUI 302. User 328 may then select one or more of the associated task(s) to add to the quest document. In a further embodiment, recommendation logic 320 may not only make recommendations of associated tasks as the quest is being created by user 328 but also as user 328 completes a task within the quest. Task logic 318 may then store all of the created/selected tasks on storage 304.

Once user 328 has selected/created a quest, user 328 sets out to complete the tasks of the quest, which may include, for example, browsing on a Website, reviewing competitor prices, looking at financing, physically analyzing the product in a store, asking a friend or other consumer about their experiences, observing in-store demonstrations, checking inventory of other locations, or the like. Additionally, user 328 may provide feedback with regard to each task within the quest. That is, user 328 may provide comments along with the particular task of the quest being performed, thereby providing guidance to the sponsor of the quest. Such information may be useful to the sponsor in order to determine whether the particular task was perceived by user 328 as being valuable toward the purchase of the product or service or whether the task had a negative impact on user's 328 decision to purchase the product or service. If a particular task has a negative impact on user 328, then the sponsor may decide to remove the task from future quests of future prospective buyers.

As user 328 completes a task, verification logic 322 attempts to verify that user 328 actually performed the associated task. While verification logic 322 may not be able to directly verify that user 328 spoke with a friend about the product of the quest, if user 328 indicates completion of such a task, then verification logic 322 may attempt to determine whether a phone call completed in a predetermined time prior to the indication of the completed task, whether user 328 has sent an email to someone that comprises an identification of the product or service, snoop social media 314 for posts associated with the product or service, whether user 328 has visited the store associated with the product or service, or the like. In order to verify whether user 328 has browsed a Website, reviewed competitor prices, looked at financing, etc., verification logic 322 may snoop the history, cookies, or the like, associated with browser 310. In order to verify whether user 328 has physically analyzed the product in a store, verification logic 322 may utilize location services associated with user's 328 smart device, request user 328 to scan a barcode or QR code associated with the product, request that user 328 take a picture with the product and submit the picture, or the like. Thus, verification logic 322 may utilize numerous verification mechanisms in order to verify that user 328 actually performed the associated task. If verification may not be made, verification logic 322 may either request additional information from user 328 or check whether verification is required by the sponsor of the quest. If the sponsor does not require verification, then verification logic 322 simply verifies the task. Otherwise, verification logic 322 requests user 328 to provide additional information. As user 328 completes each task, verification logic 322 time/date stamps the verification in order to provide an order in which the tasks were completed to the sponsor of the tasks.

As user 328 completes additional tasks, verification logic 322 repeats the verification process. Once user 328 has completed all of the tasks within the quest, reward logic 324 may initiate the presentation of the agreed-upon reward to user 328. The agreed-upon award may be an award that is agreed to before the quest was started or after the request is completed. The presentation of the agreed-upon reward may be in the form of a coupon presented in an email via email logic 312, via browser 310, or via social media 314, sending a gift card to the address of user 328 and providing a notification notifying via email logic 312, via browser 310, or via social media 314, presenting user 328 with a badge in an online gaming system, unlocking additional privileges and quests, or the like. Further, once user 328 has completed all of the tasks within the quest, results logic 326 may submit the information from the completed tasks, all context provided by user 328 in completing the tasks, verification results, and the like, to data processing system 350 associated with the sponsor of the task via network adapter 306 and Internet 330.

However, there are instances where user 328 may not complete all of the tasks and abandon the quest. In these instances, pre-purchase/post-purchase shopping activity tracking mechanism 316 also comprises timing logic 332. Timing logic 332 keeps track of the amount of time between tasks within the quest. Based on predetermined time periods provided by the sponsor of the quest, if timing logic 332 determines that the time since the completion of a previous task has exceeded the predetermined time period provided by the sponsor, then timing logic 332 may close the quest so that user 328 may not perform any more tasks as well as signal reward logic 324 that the quest has been closed. Although reward logic 324 may not initiate presentation of the agreed-upon reward to user 328, in order to promote loyalty, reward logic 324 may determine whether a reduced award may be presented to user 328 based on the percentage of completed tasks within the quest. That is, for example, if user 328 completed seventy-five percent of the tasks within the quest, then the sponsor may still want to present user 328 with a reduced reward, such as a reward that is twenty-five percent of the agreed-upon reward.

Therefore, reward logic 324 identifies the percentage of completed tasks within the closed quest and determines whether the identified percentage is above a threshold set by the sponsor to present a reduced award. Although the illustrative embodiment only refers to one threshold to use for presenting a reduced award, there may be a plurality of thresholds from which different reduced awards are presented, where the rewards are smaller in value as correlated to the percentage of completed tasks being less and the rewards being larger/smaller in value as correlated to the percentage of completed tasks being greater. However, if the percentage of completed tasks is so small that the sponsor is not willing to provide any reduced reward, then reward logic 324 does not present a reward and results logic 326 may submit all information from the tasks that are completed, all context provided by user 328 in completing those tasks, verification results, and the like, to data processing system 350 associated with the sponsor of the task via network adapter 306 and Internet 330. If the percentage of completed tasks is above the one or more thresholds such that the sponsor is willing to provide a reduced reward, then reward logic 324 presents a reduced reward as associated with the threshold that is met, submit all information from the tasks that are completed, all context provided by user 328 in completing those tasks, verification results, and the like, to data processing system 350 associated with the sponsor of the task via network adapter 306 and Internet 330.

In a further aspect of the present illustrative embodiments, the one or more existing quests may be regularly reviewed, which may result in a quest being updated, added, or deleted, where updating a quest may comprise updating, adding, or deleting a task within the quest. Review logic 352 in data processing system 350 associated with the sponsor performs this review process based on the results provided by results logic 326 in data processing system 300 which are stored as results 354 in storage 356. That is, over time, review logic 352 may determine that results 354 indicates that for exemplary quests Q1, Q2, Q3, and Q4 in quests 358, more tasks are being completed in quests Q1 and Q4 than are being completed in quests Q2 and Q3. Thus, review logic 352 may delete quests Q2 and Q3. In addition, prior to deleting quests Q2 and Q3, review logic 352 may determine for each of quests Q2 and Q3 which tasks of exemplary tasks T1-T10 have been predominately completed and determine whether those tasks, for example tasks T1, T4, and T8 in quest Q2 and T2 and T5 in quest Q3, are in quests Q1 and/or Q4. If those tasks are not in quests Q1 and Q4, then review logic 352 may add those quests to quests Q1 and/or Q4.

Further, for tasks within a kept quest, for example quest Q1, review logic 352 may review the completion rate of each of exemplary tasks T1-T15 to determine whether one or more of tasks T1-T15 should be updated or deleted. Review logic 352 may also utilize the context provided by user 328 in completing those tasks in order to determine whether user 328 felt that the task influenced user 328 to purchase the product or service or not. That is, utilizing the context provided by user 328 in completing exemplary tasks T1-T15, review logic may determine that tasks T6, T11, and T14 had no or very little influence on user 328. Thus, review logic 352 may delete those tasks from quest Q1. Additionally, over time, review logic 352 may be able to identify a set of tasks from quests 358 that have the highest influence on a set of users to purchase the service or product. Thus, review logic 352 may create a new quest Q5 that comprises all of the most influential tasks.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

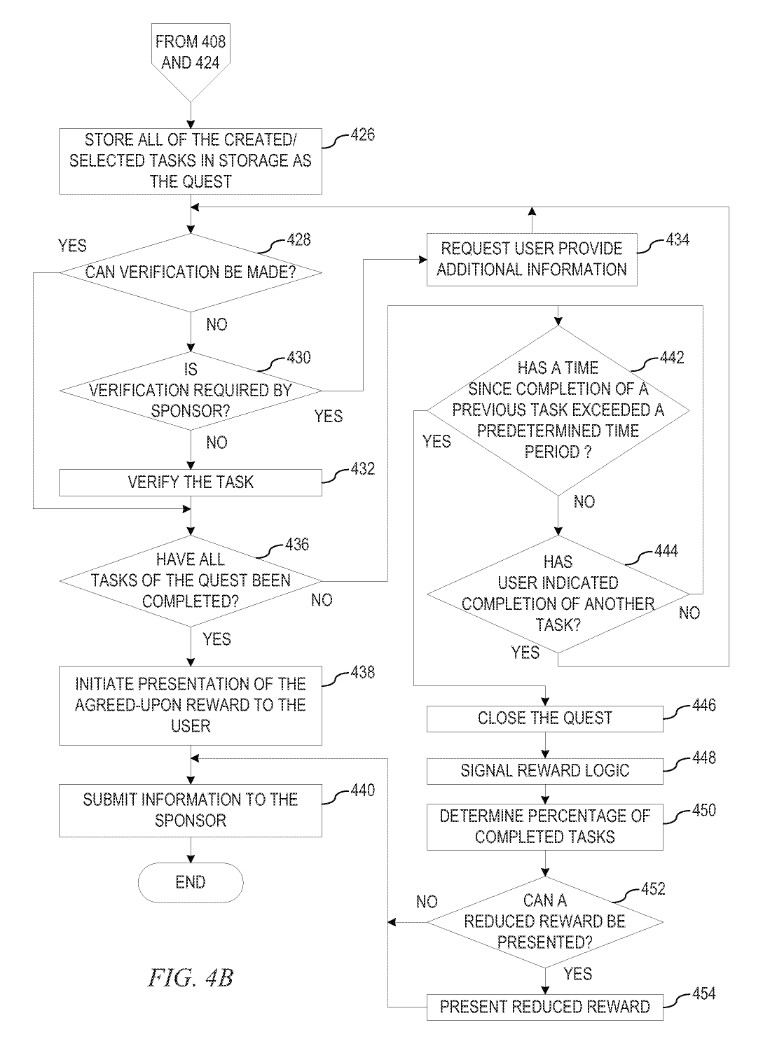

FIGS. 4A and 4B depict a flowchart of the operation performed by a pre-purchase shopping activity tracking mechanism in accordance with an illustrative embodiment. As the operation begins, task logic of the pre-purchase/post-purchase shopping activity tracking mechanism executed by a processor receives an indication from a user to participate in a quest (step 402). The task logic presents the user with an option to select a quest from one or more existing quests or create a new quest (step 404). If at step 404 the user selects to use one of the one or more existing quests, then the task logic may access the one or more existing quests to present the user with the one or more existing quests from which to select (step 406). The one or more existing quests may be accessed at business Website who is a sponsor of the advertisement, selected from elsewhere on the Internet, locally on an in-store kiosk, accessed using a scanned QR code, or the like. The task logic then receives a selection of the quest from the user (step 408). If at step 404 the user chooses to create their own quest, the task logic provides the user with a blank quest document in which user may add tasks/activities the user plans to perform in the pre-purchase/post-purchase of the associated product or service (step 410). As the user adds tasks to the quest document, the task logic associates an indicator with each added task so that, upon completion of the task, the user may provide a completion indication (step 412).

As the user adds a task to the quest document, recommendation logic of the pre-purchase/post-purchase shopping activity tracking mechanism executed by a processor determines whether the task is similar to a task in either a list of tasks or a task in the one or more existing quests (step 414). If at step 414 the recommendation logic identifies a similar task, the recommendation logic identifies whether there is one or more associated tasks (step 416). If at step 416 there are one or more associated tasks, then the recommendation logic provides the one or more associated tasks to the user (step 418). The user may then select or decline to add one or more of the one or more additional tasks to the quest being created (step 420). If at step 420 the user selects one or more of the one or more additional tasks, then the task logic adds the selected one or more additional tasks to the quest (step 422). From step 422, if at step 420 the user declines to add one or more of the additional tasks, or if at step 416 there are no associated tasks, or if at step 414 the recommendation logic fails to identify a similar task, the task logic determines whether an indication has been received indicating that the user has added all desired tasks to the quest (step 424). If at step 424 the indication is not received indicating that the user has added all desired tasks to the quest, then the operation returns to step 412.

If at step 424 the indication is that all desired tasks have been added to the quest or from step 408, then the task logic stores all of the created/selected tasks in storage as the quest (step 426). As the user completes a task in the set of tasks in the quest, verification logic in of the pre-purchase/post-purchase shopping activity tracking mechanism executed by the processor verifies whether the user actually performed the associated task (step 428). If at step 428 the verification logic fails to verify that the activity was performed with regard to the task, then the verification logic may determine whether verification is required by the sponsor of the quest (step 430). If at step 430 the sponsor does not require verification, then the verification logic simply verifies the task (step 432). If at step 430 the sponsor does require verification, the verification logic requests the user provide additional information (step 434), with the operation returning to step 428. If at step 428 the verification logic verifies activity was performed with regard to the task or from step 432, the task logic determines whether all of the tasks of the quest have been completed (step 436).

If at step 436 all of the tasks have been completed, then reward logic of the pre-purchase/post-purchase shopping activity tracking mechanism executed by a processor initiates the presentation of the agreed-upon reward to the user (step 438). Further, results logic of the pre-purchase/post-purchase shopping activity tracking mechanism executed by the processor submits the information from the completed tasks, all context provided by the user in completing the tasks, verification results, and the like to the sponsor of the task (step 440), with the operation ending thereafter.

If at step 436 all of the tasks have not been completed, then the timing logic of the pre-purchase/post-purchase shopping activity tracking mechanism executed by a processor determines whether a time since the completion of a previous task has exceeded a predetermined time period provided by the sponsor (step 442). If at step 442 the time since the completion of the previous task has not exceeded the predetermined time period provided by the sponsor, then the timing logic determines whether the user has indicated completion of another task (step 444). If at step 444 the user indicates completion of another task, then the operation returns to step 428. If at step 444 the user fails to indicate completion of another task, then the operation returns to step 442. If at step 442 the time since the completion of the previous task has exceeded the predetermined time period provided by the sponsor, then the timing logic may close the quest (step 446) so that the user may not perform any more tasks. The timing logic may also signal reward logic of the pre-purchase/post-purchase shopping activity tracking mechanism executed by a processor that the quest has been closed (step 448). The reward logic may then determine a percentage of completed tasks within the closed quest (step 450). Based on the percentage of completed tasks within the closed quest, the reward logic may determine whether a reduced award may be presented to user (step 452). If at step 452 the reward logic determines that the percentage of completed tasks is so small that the sponsor is not willing to provide any reduced reward, then the reward logic does not present a reward and the operation proceeds to step 440. If at step 452 the reward logic determines that the percentage of completed tasks is above the one or more thresholds such that the sponsor is willing to provide a reduced reward, then the reward logic presents a reduced reward as associated with the threshold that is met (step 454), with the operation proceeding to step 440 thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for tracking pre-purchase/post-purchase shopping activities and rewarding potential customers based on the customer's pre-purchase/post-purchase shopping activities. Utilizing the mechanisms of the illustrative embodiments businesses may propose rewards based upon non-purchase activities conducted via email, the Internet, social media, apps, non-purchase store visits, or the like. A customer creates and/or completes ‘quests’, which are collections of tasks that the customer completes during their own pre-purchase/post-purchase activities. These quests may then be analyzed by a business in relation to purchasing behavior to determine which quests may be most useful for marketing. These quests could be combined with other data collected by a marketer to unlock additional quests, build towards alternate achievements, optimize rewards for the shopper, etc. While these quests may be business-created quests, the illustrative embodiments recognize that the quest may also include business-created quests modified by the customer, customer generated quests tied to the business, quests generated by other customer related to a previous purchase made from the business, or the like. Additionally, the quest may provide context around the intent of the particular quest by allowing the user to provide comments along with the particular action of the quest being performed, thereby providing guidance to the marketers of the business.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for tracking and facilitating pre-shopping/post-purchase activity, the method comprising:
receiving, by a processor, an indication that a user has completed a task in a set of tasks of a quest, wherein the quest is a pre-purchase/post-purchase shopping activity quest;
verifying, by the processor, whether the task has been completed;
responsive to verifying the task has been completed, determining, by the processor, whether all of the set of tasks of the quest have been completed;
responsive to all of the set of tasks being completed, initiating, by the processor, a presentation of an agreed-upon reward to the user; and
submitting, by the processor, all information from quest to a sponsor of the quest.

2. The method of claim 1, wherein the verification is performed by the method comprising at least one of:
determining, by the processor, whether a phone call completed in a predetermined time prior to the indication of the completed task;
determining, by the processor, whether an email was sent to someone that comprises an identification of a product or a service associated with the quest;
determining, by the processor, whether a social media post was posted that comprises the identification of the product or the service associated with the quest;
determining, by the processor, whether a history of a browser indicates that a web page was visited that comprises the identification of the product or the service associated with the quest;
determining, by the processor, whether a cookie has been set in the browser indicating that a web page was visited that comprises the identification of the product or the service associated with the quest;
determining, by the processor, whether a picture has been taken with the product associated with the quest;
determining, by the processor, whether a user has visited a location associated with where the product or service is sold; or
determining, by the processor, whether the user has scanned either a barcode or QR code associated with the product or service.

3. The method of claim 1, further comprising:
responsive to a failure to verify whether the task was completed, determining, by the processor, whether verification is required by a sponsor of the quest; and
responsive to verification not being required, verifying, by the processor, the task as complete.

4. The method of claim 3, further comprising:
responsive to verification being required, requesting, by the processor, additional information from the user; and
responsive to receiving the additional information, re-verifying, by the processor, whether the task has been completed.

5. The method of claim 1, wherein the quest is an existing quest selected by the user from a list of sponsor built quests or a list of previous shopper quests.

6. The method of claim 1, wherein the quest is a new quest created by the user, and wherein the new quest is created by the method comprising:
presenting, by the processor, the user with a quest document that is blank;
receiving, by the processor, one or more new tasks from the user to add to the quest document; and
adding, by the processor, the one or more new tasks to the quest document.

7. The method of claim 6, further comprising:
for each new task added to the quest document:
associating, by the processor, an indicator with each new task, wherein the indicator is used by the user to indicate completion of the new task;
determining, by the processor, whether a similar task similar to the new task exists in at least one of a list of tasks or in one or more existing quests;
responsive to identifying the similar task, determining, by the processor, whether there is one or more associated tasks;
responsive to identifying the one or more associated tasks, presenting, by the processor, the user with the one or more associated tasks; and
responsive to receiving a selection from the user of one or more of the one or more additional tasks, adding, by the processor, the one or more additional tasks to the quest document.

8. The method of claim 1, further comprising:
responsive to all of the set of tasks failing to be completed, determining, by the processor, whether a time period for completing the set of tasks has expired; and
responsive to the time period expiring, submitting, by the processor, all information from quest to the sponsor of the quest.

9. The method of claim 1, further comprising:
determining, by the processor, a completion rate for each task in a set of tasks within one or more existing quests; and
responsive to the completion rate being below a predetermined threshold for task completion, modifying, by the processor, one or more quests of the one or more existing quests.

10. The method of claim 9, wherein modifying the one or more quests of the one or more existing quests comprises at least one of:
deleting, by the processor, the one or more quests;
removing, by the processor, one or more tasks in the set of tasks within the one or more quests;
adding, by the processor, one or more tasks in the set if tasks within the one or more quests to another quest in the one or more quests; or
creating, by the processor, a new quest utilizing influential tasks from the set of tasks in the one or more existing quests.

11. A computer program product comprising a computer readable storage medium having a computer readable program stored therein, wherein the computer readable program, when executed on a computing device, causes the computing device to:
receive an indication that a user has completed a task in a set of tasks of a quest, wherein the quest is a pre-purchase/post-purchase shopping activity quest;
verify whether the task has been completed;
responsive to verifying the task has been completed, determine whether all of the set of tasks of the quest have been completed;
responsive to all of the set of tasks being completed, initiate a presentation of an agreed-upon reward to the user; and
submit all information from quest to a sponsor of the quest.

12. The computer program product of claim 11, wherein the computer readable program verifies the task has been completed by further causing the computing device to perform at least one of:
determine whether a phone call completed in a predetermined time prior to the indication of the completed task;
determine whether an email was sent to someone that comprises an identification of a product or a service associated with the quest;
determine whether a social media post was posted that comprises the identification of the product or the service associated with the quest;
determine whether a history of a browser indicates that a web page was visited that comprises the identification of the product or the service associated with the quest;
determine whether a cookie has been set in the browser indicating that a web page was visited that comprises the identification of the product or the service associated with the quest;
determine whether a picture has been taken with the product associated with the quest;
determine whether a user has visited a location associated with where the product or service is sold; or
determine whether the user has scanned either a barcode or QR code associated with the product or service.

13. The computer program product of claim 11, wherein the computer readable program further causes the computing device to:
responsive to a failure to verify whether the task was completed, determine whether verification is required by a sponsor of the quest; and
responsive to verification not being required, verify the task as complete.

14. The computer program product of claim 13, wherein the computer readable program further causes the computing device to:
responsive to verification being required, request additional information from the user; and
responsive to receiving the additional information, re-verify whether the task has been completed.

15. The computer program product of claim 11, wherein the quest is a new quest created by the user, and wherein the computer readable program creates the new quest by causing the computing device to:
present the user with a quest document that is blank;
receive one or more new tasks from the user to add to the quest document; and
add the one or more new tasks to the quest document.

16. The computer program product of claim 15, wherein the computer readable program further causes the computing device to:
for each new task added to the quest document:
associate an indicator with each new task, wherein the indicator is used by the user to indicate completion of the new task;
determine whether a similar task similar to the new task exists in at least one of a list of tasks or in one or more existing quests;
responsive to identifying the similar task, determine whether there is one or more associated tasks;
responsive to identifying the one or more associated tasks, present the user with the one or more associated tasks; and
responsive to receiving a selection from the user of one or more of the one or more additional tasks, add the one or more additional tasks to the quest document.

17. An apparatus, comprising:
a processor; and
a memory coupled to the processor, wherein the memory comprises instructions which, when executed by the processor, cause the processor to:
receive an indication that a user has completed a task in a set of tasks of a quest, wherein the quest is a pre-purchase/post-purchase shopping activity quest;
verify whether the task has been completed;
responsive to verifying the task has been completed, determine whether all of the set of tasks of the quest have been completed;
responsive to all of the set of tasks being completed, initiate a presentation of an agreed-upon reward to the user; and
submit all information from quest to a sponsor of the quest.

18. The apparatus of claim 17, wherein the instructions verify the task has been completed by further causing the processor to perform at least one of:
determine whether a phone call completed in a predetermined time prior to the indication of the completed task;
determine whether an email was sent to someone that comprises an identification of a product or a service associated with the quest;
determine whether a social media post was posted that comprises the identification of the product or the service associated with the quest;
determine whether a history of a browser indicates that a web page was visited that comprises the identification of the product or the service associated with the quest;
determine whether a cookie has been set in the browser indicating that a web page was visited that comprises the identification of the product or the service associated with the quest;
determine whether a picture has been taken with the product associated with the quest;
determine whether a user has visited a location associated with where the product or service is sold; or
determine whether the user has scanned either a barcode or QR code associated with the product or service.

19. The apparatus of claim 17, wherein the instructions further cause the processor to:
responsive to a failure to verify whether the task was completed, determine whether verification is required by a sponsor of the quest; and
responsive to verification not being required, verify the task as complete.

20. The apparatus of claim 19, wherein the instructions further cause the processor to:
responsive to verification being required, request additional information from the user, and
responsive to receiving the additional information, re-verify whether the task has been completed.

21. The apparatus of claim 17, wherein the quest is a new quest created by the user, and wherein the instructions create the new quest by causing the processor to:
present the user with a quest document that is blank;
receive one or more new tasks from the user to add to the quest document; and
add the one or more new tasks to the quest document.

22. The apparatus of claim 21, wherein the instructions further cause the processor to:
for each new task added to the quest document:
associate an indicator with each new task, wherein the indicator is used by the user to indicate completion of the new task;
determine whether a similar task similar to the new task exists in at least one of a list of tasks or in one or more existing quests;
responsive to identifying the similar task, determine whether there is one or more associated tasks;
responsive to identifying the one or more associated tasks, present the user with the one or more associated tasks; and
responsive to receiving a selection from the user of one or more of the one or more additional tasks, add the one or more additional tasks to the quest document.
